(19) United States
(12) Patent Application Publication
(10) Pub. No.: US 2010/0108825 A1
(43) Pub. Date: May 6, 2010

(54) FOAM SUPPORT FOR LINE PIPE

(76) Inventor: Robert D. Brock, Grand Haven, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/577,981

(22) Filed: Oct. 13, 2009

Related U.S. Application Data
(60) Provisional application No. 61/110,663, filed on Nov. 3, 2008.

(51) Int. Cl. F16L 3/08

(52) U.S. Cl. 248/73; 248/65

(57) ABSTRACT

A series of contoured pipe supports made primarily of foam are designed to support line pipe across land or water. The supports are configured to snap onto and self-retain to the line pipe, and further are configured to resist permanent deformation and to withstand weather conditions. The foam of the supports have sufficient physical and mechanical properties to support the line pipe, but the supports are surprisingly lightweight and can be easily installed over pipes for the purpose of supporting and protecting such pipe until the pipe is buried or submerged in the earth. The supports are sufficiently durable and have sufficient flotation to maintain a line pipe in a horizontal position necessary to prevent accidental puncture or leakage of the pipe during assembly and installation.

This application claims benefit under 35 U.S.C. §119(e) from provisional application Ser. No. 61/110,663, filed Nov. 3, 2008, entitled FOAM SUPPORT FOR LINE PIPE.

### BACKGROUND

The present invention relates to installation of and supports for line pipe, and more particularly relates to supports for line pipe (such as underground pipe lines that extend for long distances) that can be produced at relatively low cost, that are easier and less expensive to install during construction than known systems, and that lead to an improved, more efficient, more robust, and safer installation of line pipe in the field.

Long runs of pipe are made up of multiple sections of pipe welded together (or otherwise secured together) to form a long continuous length, such as for transporting liquids and gases or other semi-liquid materials long distances. This pipe is commonly called “line pipe.” In the case of line pipe that is assembled for use below the ground, a trench is dug to house the pipe. The trench is made using various tools such as a backhoe or other excavation equipment to form a continuous long trench to set the pipe in. The pipe sections are extremely long, as much as 40′ (feet) per section, and since they are often constructed in difficult/remote locations, it is virtually impossible to make the floor of the trench perfectly flat and stable. Thus, when the pipe is set down on this floor, the construction engineers are not absolutely sure that the pipe is evenly supported. This can be a problem since uneven support can lead to stress and damage to the line pipe, including both immediate damage and also delayed damage that takes awhile before it results in leakage. Such leakages are extremely expensive and difficult to repair in the field. Another problem occurs if the line pipe contacts a hard object that causes damage to the pipe (potentially undetected damage), either during construction or due to movement of earth over time causing the buried object to move against the line pipe.

Often, line pipe is welded above the ground to form the continuous length of pipe, and then the welded product is lowered down into the trench and buried. These long sections of line pipe have some flexing ability for this lay-in procedure, but are intended to lay in a more or less straight line once laid into the trench. Thus, the potential problems noted above are still present. Further, there is a need to maintain this straight line alignment in both linear and horizontal directions. There are different methods currently used to do this.

One method uses a bag filled with fine grain sand, which is then placed in the bed of the trench. These bags must be located within the trench by semi-skilled workers in order to maintain the straight line alignment and levelness of the bags along the entire length of the trench. This method requires sand of a specified grit size, and further that the bags must be transported along the entire length of the trench and manually lowered into the trench. The workers must get into the trench and place the bags accordingly, which is a messy and potentially unsafe position for workers. Pipe lines are known to extend for hundreds of miles, so this is a costly operation that must be repeated along the entire length of the line. This method is manually intensive, and further transport of the sand and bags to the construction site is expensive due in part to their weight.

A second method uses a special truck containing foam-making equipment. The line pipe is lowered into the trench and an operator that is skilled in the application of foam will lay a bed of foam under and around the pipe to support the line pipe. Since there is a certain cure time for the foam, this is a time-consuming process that requires that the pipe be held in a specific location, both horizontally and laterally, for a length of time necessary to cure the foam sufficiently to support the line pipe. Several operators and an expensive truck equipped to carry and spray foam must travel parallel to the trench along the entire length of the line pipe. Any mechanical breakdown of either the foam-making equipment or the truck will slow down the process of laying the pipe. Further, the foaming chemicals, which are potential environmental pollutants, must be transported over difficult terrain.

### SUMMARY OF THE PRESENT INVENTION

The present invention provides for a solution to support line pipe in a much easier and concise manner than previously existed. Instead of filling sand bags or forming a pipe support on site by foaming in place, the present invention includes providing a profiled block of foam cut to form a support (also called a “foam block support” herein) that can be snapped onto the line pipe at any interval and then manipulated to a bottom-facing use position on the line pipe, such as one being at or near a longitudinal center of the pipe and others being along the line pipe at various spaced locations, such as at a distance of about 2 to 3 feet from the welded joints at ends of pipe sections. Since the design of the profile is consistent for each piece, the pipe will be inserted within the trench in a manner that allows the foam block to control the height of the pipe within the trench in a consistent manner Advantageously, the physical properties of EPS (expanded polystyrene) are such that the profile of the foam block can be made to include two opposing fingers that permit snap-on attachment to the pipe, but that are designed to allow an unskilled operator to place them over the pipe (such as onto a top of the pipe) and then adjust their longitudinal and/or rotational position to avoid incorrect placement or misalignment when the line pipe is placed in the trench. Gravity assists in assembling the supports onto the line pipe and also in rotating the supports to use positions under the line pipe to form a base parallel to the ground (or floor of a trench). Testing shows that the physical properties of EPS foam material are such that the present foam block supports readily support a weight of the line pipe, and are not adversely deformed by the weight.

In one aspect of the present invention, a support is provided for line pipe with known diameter, where the support includes a foam block cut to define a concavity shaped to receive the line pipe of known diameter.

In another aspect of the present invention, a method comprises steps of providing interconnected pipe sections forming a line pipe construction; placing pre-formed foam supports on the interconnected pipe sections; and resting the line pipe on the foam supports and the foam supports on a floor surface to thus support the line pipe.

An object of the present invention is to use the physical properties of EPS to provide a support designed to allow for a safe and effective and more efficient method of construction/installation, and further that allows a relatively easy delivery of material to the worksite due to its light weight and durability.

An object of the present invention is to utilize EPS material in a support for line pipe, taking advantage of the EPS material's very lightweight material, such as by making foam block supports out of densities of approximately 3 pounds per cubic foot, or even 2 pounds per cubic foot, or in many applications even 1 pound per cubic foot.

An object of the present invention is to construct a support that is made of a material that is environmentally safe and relatively inert, such that its use does not create an environmental hazard.

An object of the present invention is to make foam block supports that can be placed along the path of the pipe trench with very little physical effort on the part of an unskilled worker.

An object of the present invention is to construct a line pipe support that can be inserted onto the line pipe by an unskilled worker without ever having to enter the trench to arrange bags or use equipment to foam in place.

An object of the present invention is to provide foam block supports that provide flotational support of line pipe across soft land areas and swampy areas, even where there is a presence of water.

An object of the present invention is to allow pipe sections to be welded together in a pre-build of the line pipe above the ground, and then have a means to support the pipe across the surface of the water before intentionally submerging the pipe to its final resting position underwater.

An object of the present invention is to construct a support for line pipe that is lightweight but is capable of supporting up to about 70 pounds per cubic foot.

An object of the present invention is to construct a support for line pipe from a foam block that will allow the line pipe to float until such time that it is desired to sink the pipe to its final location below the water level.

An object of the present invention is to construct a foam block support from low density foam, such as less than 3 pounds per cubic foot—and in many applications as low as 2 pounds per cubic foot or even 1 (or less) pound per cubic foot.

An object of the present invention is to construct a support with opposing fingers having a profile that allows them to resiliently slide over a round surface without permanent deformation (i.e., the supports can be snapped onto the line pipe in a self-retaining position), where the fingers hold the entire mass of the block suspended on the line pipe yet permit fine adjustment on the supports on the line pipe.

An object of the present invention is to provide foam block supports shaped to support pipe diameter of 1 inch to 48 inches, yet where a total weight of the supports are less than about 50 pounds, and more typically less than about 10 pounds, and in many circumstances less than 5 pounds.

An object of the present invention is to provide foam block supports shaped to support line pipe, above or below ground, and through various and different ground compositions, including different levels of moisture content and even high water content.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a typical foam block support embodying the present invention.

FIGS. 2 and 3 are plan views of two EPS foam block supports similar to that in FIG. 1, FIG. 2 showing a support for a 24 inch diameter pipe, and FIG. 3 showing a support for a 12 inch diameter pipe.

FIG. 4 is a perspective view showing a line pipe installation/construction.

FIGS. 5-7 are perspective, end, and side views of a modified support.

FIGS. 8-10 and 11-13 are perspective, end, and side views of second and third modified supports.

FIGS. 14-16 are perspective, end, and side views of another modified support made of multiple parts, and FIGS. 17-18 are top and side views of one of those parts and FIGS. 19-20 are top and side views of another one of those parts.

### DETAILED DESCRIPTION OF PREFERRED EMBODIMENTS

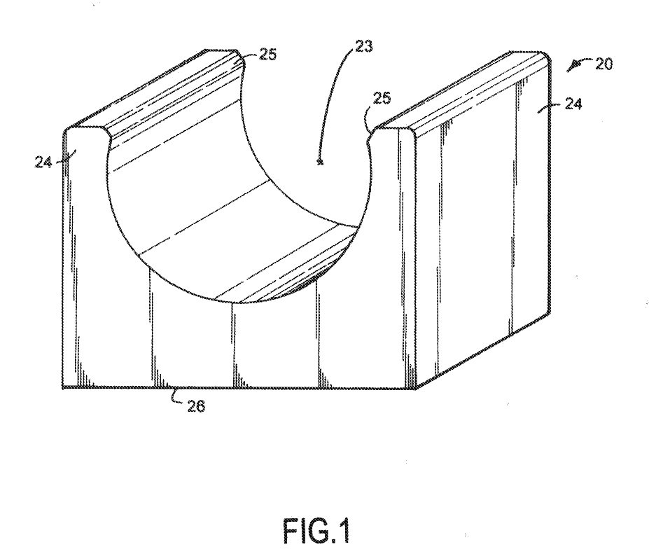

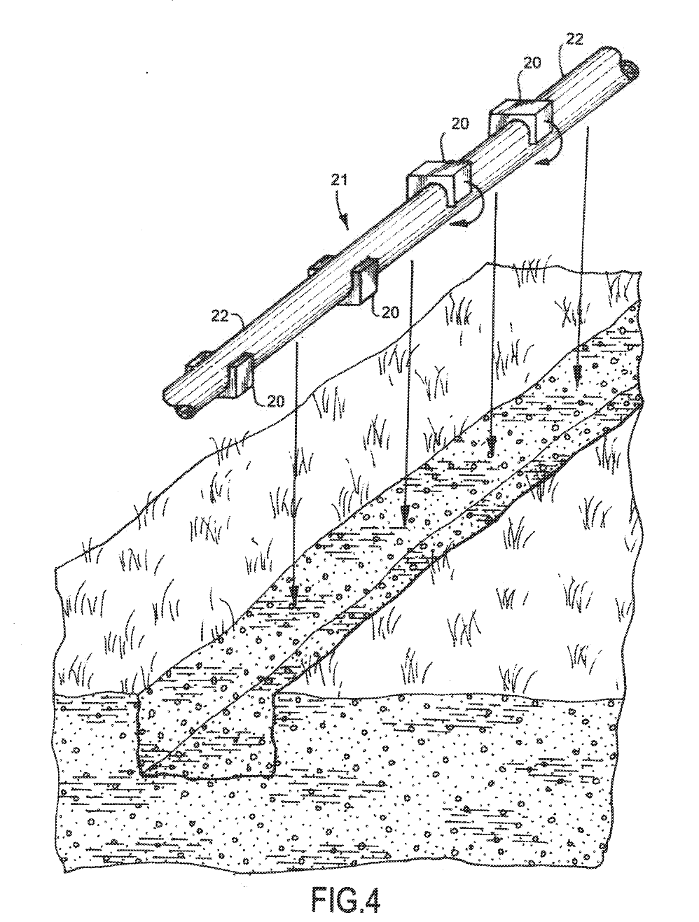

A series of contoured pipe supports 20 (FIGS. 1-4) made primarily of foam are designed to support line pipe 21 across land or water. Line pipes 21 are commonly made by welding together pipe sections 22, such that the line pipe 21 extends for miles. The supports 20 are configured to snap onto and self-retain to the line pipe 21, are configured to rotate and/or slide to a use position on the pipe 21, and further are configured to resist permanent deformation and to withstand weather conditions. The foam of the supports 20 have sufficient physical and mechanical properties to support the line pipe 21, but the supports 20 are surprisingly lightweight and can be easily installed over pipes 21 for the purpose of supporting and protecting such pipe until the pipe is buried or submerged in the earth. The supports 20 are also sufficiently durable and have sufficient flotation properties to maintain a line pipe 21 in a horizontal position necessary to prevent accidental puncture or leakage of the pipe 21 during assembly and installation.

The illustrated support 20 (FIG. 1) is cut from a precast EPS foam block to include a concavity 23 generally matching a diameter of a pipe section 22. Opposing fingers 24 define an entrance to the concavity 23. The fingers 24 include an angled surface 25 on their tips to facilitate sliding the supports 20 onto a pipe section 22. The fingers 24 define an entrance dimension that is slightly less than a diameter of the pipe section 22, such as ¼ inch to ½ inch less on each side of the entrance, but the fingers 24 have sufficient structure such that they are not permanently deformed or broken during the installation/pipe-attachment process. The concavity 23 is sufficiently large to allow the support 20 to be installed vertically from above onto the pipe section 22 (with gravity helping the attachment process), and further to allow the support 20 to be rotated to a downwardly-facing bottom use position. The support 20 includes a flat bottom surface 26 adapted to stably engage the ground or flat floor surface of a trench. Notably, a size of the bottom surface 26 can be extended (or reduced) longitudinally or in a width direction in order to adapt a particular support 20 for a particular application. Further, by changing the support's size, its flotational properties are also affected. Notably, the foam material can deform locally in a manner to assist in smoothing out stress from hard objects such as rocks or other hard debris in the trench where the line pipe 21 is being placed.

The present invention provides for a solution to support line pipe in a much easier and concise manner than previously existed. Instead of filling sand bags or foaming in place, the present invention includes providing a profiled block of foam cut to form a support that can be snapped in place over the line pipe at any interval. Most commonly foam supports are placed at or near the center of the pipe and at a distance of about 2 to 3 feet from the welded joints. Since the design of the profile is consistent for each piece, the pipe will be inserted within the trench in a manner that allows the foam block to control the height of the pipe within the trench in a consistent manner. Advantageously, the physical properties of EPS (expanded polystyrene) are such that the profile of the foam block can be made to include two opposing fingers that extend above the center of the line pipe. These fingers are designed to allow an unskilled operator to place them over the pipe (such as onto a top of the pipe) without fear of incorrect placement or alignment when the line pipe is placed in the trench. The foam supports can be adjusted along and/or around the line pipe after being placed on the line pipe. With the help of gravity, each foam block is rotated in place to a position under the line pipe to form a base parallel to the ground (or floor of a trench).

Testing has shown that the physical properties of EPS foam material are such that the weight of the pipe when exerting a load on the foam block supports will not adversely deform the foam block supports if appropriate densities of foam material are selected. Hence, a weight of the pipe will not affect the ability of the foam block supports to set substantially on the surface of the trench bed and allow for easy alignment and protection of the line pipe.

In addition to the physical properties of EPS, the design of this product allows for a safe and effective method of construction/installation, and further allows a relatively easy delivery of material to the worksite due to its light weight and durability. For example, EPS is a very lightweight material, and foam block supports can be made of densities of approximately 1 pound per cubic foot (or lower, especially with tolerances) to as much as 2 or 3 (or higher if required) pounds per cubic foot. Further, this material is easily transportable. Still further, the material is environmentally safe and relatively inert, such that its use does not create an environmental hazard. The foam block supports can be placed along the path of the pipe trench with very little physical effort on the part of an unskilled worker. The EPS material can be inserted on the line pipe by an unskilled worker without ever having to enter the trench to arrange bags or use equipment to foam in place. Further, there is no need for a worker to wait until a foam mixture has cured sufficiently to support the weight of the line pipe.

In addition to mechanical supports, these same blocks can be fashioned to permit the flotation of line pipe across soft land areas, even where there is a presence of water. In some cases, it is necessary to lay line pipe across bodies of water. In these instances, it is advantageous to build the pipe above the ground and then have a means to support the pipe across the surface of the water before intentionally submerging the pipe to its final resting position underwater. In this case, an EPS foam block support can be designed to substantially support the weight of the pipe as a flotation device. For example, EPS is capable of supporting up to about 70 pounds per cubic foot. By a simple calculation of the weight of the pipe, it is possible to design a foam block support that will allow the line pipe to float until such time that it is desired to sink the pipe to its final location below the water level. At that time, the line pipe can be sunk by known means, such as by using cement or other heavy material to weigh down the assembly.

Notably, the present foam block support includes various features that facilitate and optimize its function and use during construction. The illustrated foam support is preferably made from a low density foam, such as less than 3 pounds per cubic foot—and in many applications as low as 2 pounds per cubic foot or even 1 pound per cubic foot (+/−tolerances, thus often down to 0.8 pounds per cubic foot). The opposing fingers have a profile that allows them to slide over a round surface without permanent deformation (i.e., the supports can be snapped onto the line pipe in a self-retaining position). The profile fingers hold the entire mass of the block suspended on the line pipe. The profiled fingers deflect when a force is applied in the direction of the center of a round object such that they stay substantially about the center of the round object. When the force that causes the block support to relocate to the center of the round object is removed, the block support will remain substantially about the center of the round object. The foam block supports are useful as a flotation supporting system for line pipe. A wide base surface of the foam block supports allows the center of a supported pipe to locate close to the bottom of a body of water (e.g., a lake bottom). Despite the foam block support's durability and size, an entire block weight of a typical support for a pipe diameter of 8 inches to 48 inches is less than about 50 pounds, and more typically less than 10 pounds, and in many circumstances less than 5 pounds.

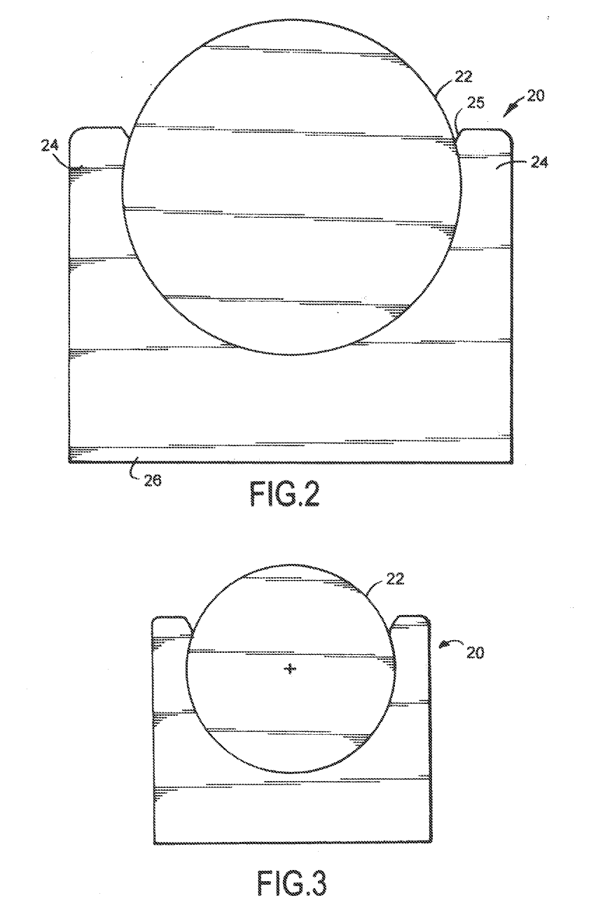

It is contemplated that a proportional increase of finger interference can be provided for successively larger diameters of the line pipe. It is contemplated that a single large block of foam can be cut to produce a plurality of foam supports for large diameter line pipe. It is further contemplated that a same large foam block or sheet can be used to cut a plurality of different supports for large and small supports, with the small support being cut from the scrap foam taken from the concavity of a larger support. It is also contemplated that a long log-like profile can be cut with a shape like that shown in FIG. 2 or 3, and then individual supports can be cut from the “log” to desired lengths either at the manufacturing site or at the installation/construction site.

FIG. 2 is a drawing showing a typical section of a support cut from an EPS or shaped foam block that has mechanical fingers extending past 180 degrees to approximately ½ to ⅛ inch smaller than the diameter of the pipe. In FIG. 2, a size of the pipe is 24 inches in diameter. The support 20 is 24 inches high and 32 inches wide and 12 inches long, and is cut by hot wire from a precast block of EPS foam. The fingers extend about 3 to 4 inches above a centerline of the pipe, and are about 3 to 4 inches in width at their thinnest point (i.e., at a location even with the centerline of the pipe). In other words, the fingers extend beyond the centerline of the pipe and cause/allow the foam block support to snap onto and be retained on the line pipe when installed over the pipe. Further, the support supports and places pressure against the bottom surface of the pipe in a direction towards the center of the pipe. The diameter of the block is such that when installed over the pipe, the block will freely (or with a slight resistance) be able to rotate from its top-installed position on the pipe to a position under the pipe where it is parallel to the bottom surface of the trench or floor surface that it is intended to sit upon. The illustrated support 20 in FIG. 2 is made from 1 pound per cubic foot EPS material, and has a compressive resistance at about 1% deformation of 7 psi. (i.e., Type 1, 0.9 lbs/sq ft). The illustrated support with 24 inch diameter recess will support a load at 12 inches length of about 2499 pounds with 1% deformation. Using similar calculations, a support for a 12 inch diameter pipe can support a maximum load at 12 inches length of about 1183 pounds with 1% deformation.

FIG. 3 is a drawing showing another typical section of a support cut from an EPS or shaped foam block intended to allow line pipe to float. For this block the physical size of the foam section is such that the L×H×W dimension will carry a load of 70 pounds per cubic foot is such that the pipe will float in water when several of these sections are snapped in place around the pipe. It is most commonly understood that the W dimension should be greater than the H dimension. This allows for a more substantial base to support the pipe during flotation and also allows the pipe, when located at the base of the water, to be located nearest the absolute bottom of such body of water. It will support a maximum flotation load of 70 pounds for each cubic foot of material contained within the shaped foam block support.

The present block support includes specific details of the profile that are intended to perform in like manner despite its increase in physical size. Since there are specific specifications for pipe (also called line pipe), the features that make up the predominate profile repeat themselves as the pipe sizes increase. The base material of the illustrated block support is lightweight foam, such as 3 pounds per cubic foot or more preferably 2 or even 1 pound per cubic foot. The results are low-weight, high-load-bearing capacity profiled block supports of 10 pound or less. The weight of the supports could be somewhat higher for large pipes up to 48 inches in diameter. These low-weight block supports can easily be moved and lifted to a position that allows easy installation around the pipes. The exterior surface of the blocks are non-finished lightweight foam as is caused by heating a wire and cutting the surface of a virgin raw block of foam with this heated wire. The shape is preferred to be flat on the bottom to allow the support to have good stable contact with a flat floor surface or a shaped trench produced by conventional machines for such purpose.

The blocks are each based on a conventional size to accommodate common pipe sizes. For example the illustrated block support (FIG. 1) is wire cut from a larger foam block to have a bottom surface of about 1.5 times the diameter of the pipe. Each finger is to extend above the centerline of the pipe to a point that is sufficient to allow the finger to always be in contact with the pipe member without becoming disengaged with the pipe if suspended in the air with the base in a position nearest the ground. The fingers must be contoured to easily slide over the pipe. This engagement surface is of a sufficient angle projecting from the top surface of the block into radius R to cause the contact with the pipe to easily become self-centering and slide over the pipe surface. At the point of the inward structure 24 at the entrance to the cavity, the pipe passes over the center most point of the pipe and becomes affixed radially about the pipe.

The foam block preferably should be such that the lowermost section of the pipe profiled surface to the base allows sufficient distance from the lowermost section of the pipe to allow for variation in the trench without the line pipe contacting the trench floor along the length of the line pipe.

The load-carrying capability should preferably be such that the compressive resistance of low density foam at 1% deflection has a safety factor of about 100% relative to the load-carrying capability of foam based on a factor of 7.0 pounds per square inch. The flotation characteristic of the illustrated block support is about 70 pounds per cubic foot.

It is contemplated that the present foam block supports are also useful for supporting utility-carrying line pipe, which can be 1-2 inch diameter pipes, buried underground.

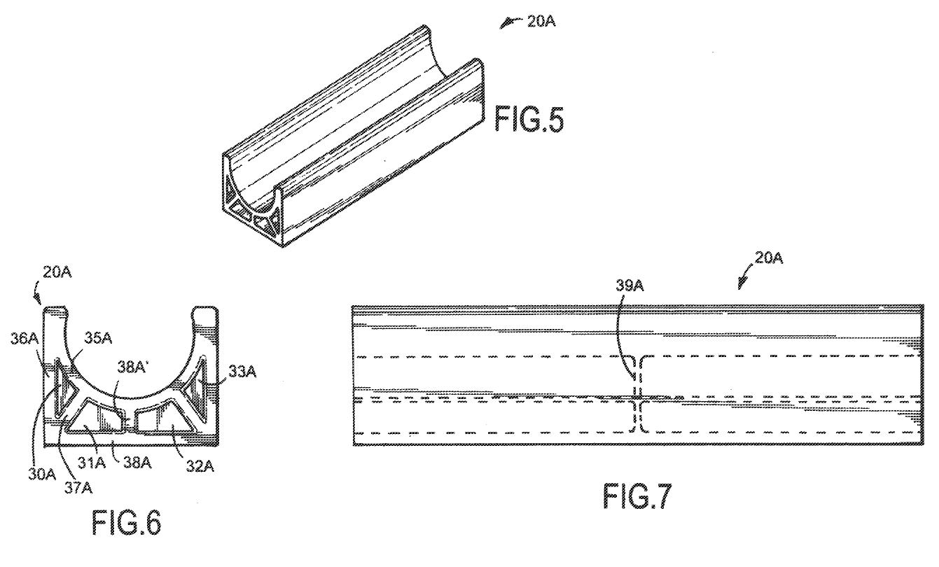

Modified supports are shown in FIGS. 5-20. In these embodiments, identical and similar features, characteristics, and aspects are identified using similar numbers, but with the addition of a letter “A,” “B,” etc. This is done to reduce redundant discussion.

The illustrated support 20A is precast EPS foam block having a concavity 23A generally matching a diameter of a pipe section 22, and includes opposing fingers 24A, an angled surface 25A, and a flat bottom surface 26A adapted to stably engage the ground, similar to the support 20 noted above. Like support 20, the support 20A provides for a solution to support line pipe and for installation method that are much easier than in known prior practices. Further, support 20A minimizes material volume while maximizing material at strategic locations for optimal strength, durability, robustness, and ease of installation (including low weight).

Specifically, support 20A (FIGS. 5-7) is a modified foam component for supporting line pipe, where large cavities 30A-33A of material are formed in the support 20A at locations where physical presence of foam is not as necessary for supporting the line pipe. Specifically, cavity 30A is triangular, and is defined by a section of material 35A defining the inner surface 25A for engaging/supporting the line pipe, and defined by a section of material 36A forming an outer wall support structure, and defined by a section of material 37A forming a bottom wall support structure. The sections 35A-37A are sufficient in thickness to provide a stability and longitudinal support strength as necessary for the particular functional requirements of a job. For example, their thickness can be less than about 2 inches in applications for supporting small diameter line pipe, or 4-5 inches (or more) in applications for supporting large diameter line pipe. Wall sections 38A and 38A′ combine with section 35A and 37A to form the cavity 31A. The cavities 32A and 33A are mirror images of cavities 30A and 31A. The cavities 30A-33A can extend completely through the support, or can terminate at an intermediate transverse wall, such as transverse wall 39A located in a middle of the support. On the supports, the corners leading to the cavities 30A-33A are beveled to minimize a tendency to break off chunks of the foam material, which can reduce problems if the foam block supports are roughly handled.

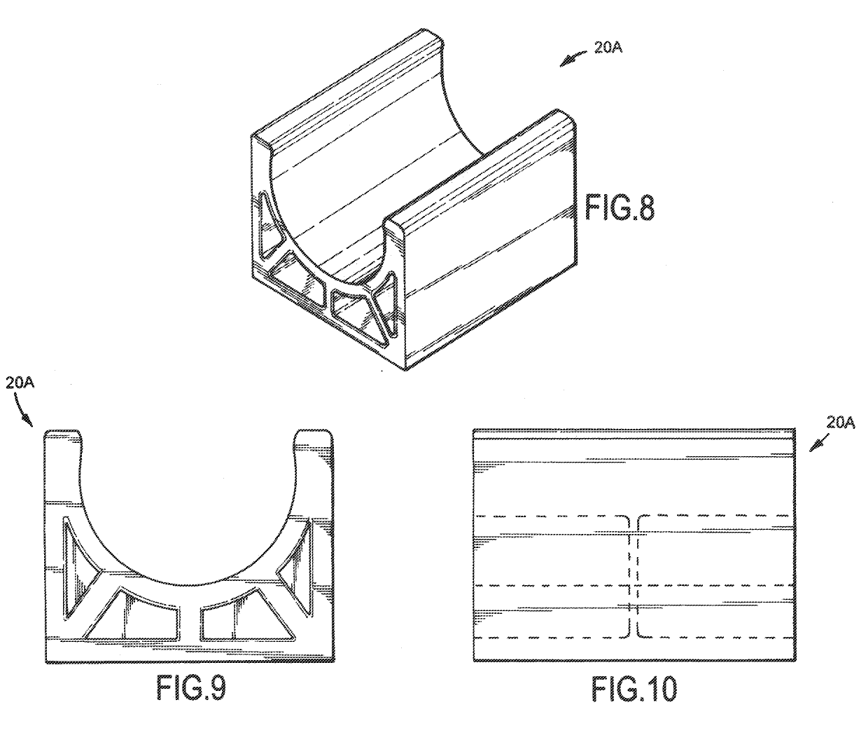

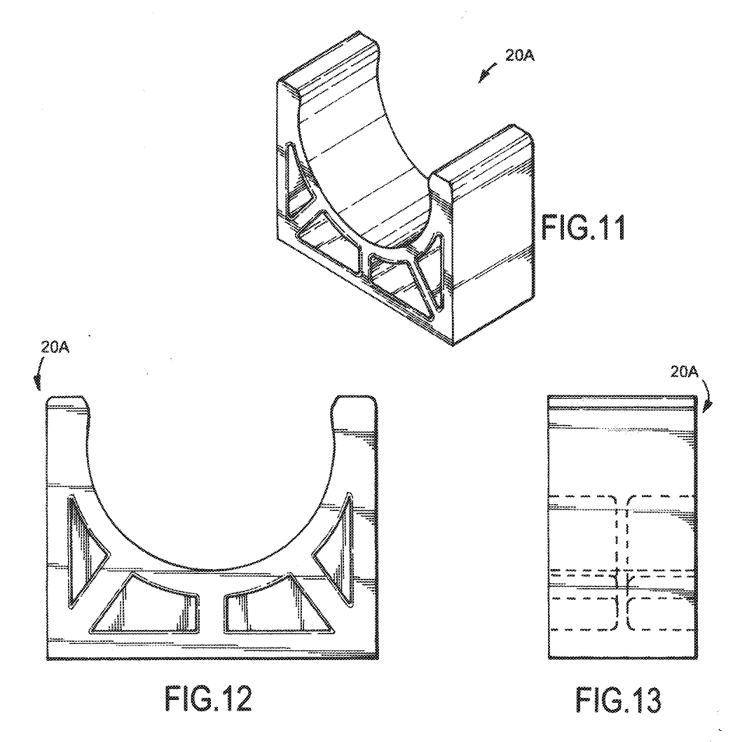

FIGS. 8-10 and 11-13 are perspective, end, and side views of second and third modified supports that very similar to support 20A but with different cavity sizes (for engaging different diameter line pipes) and also different dimensions. For example, the support of FIGS. 5-7 is 5.3 inches wide, 4 inches high, and 18 inches long. The support of FIGS. 8-10 is 16 inches wide, 12 inches high, and 18 inches long. The support of FIGS. 11-13 is 40 inches wide, 30 inches high, and 18 inches long.

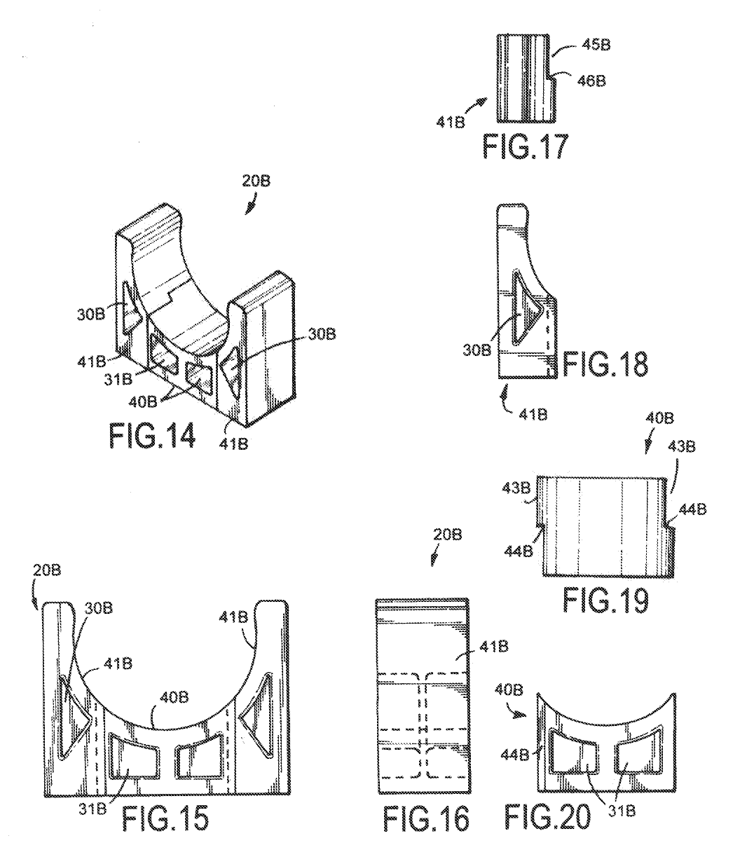

Notably, the supports can be made of multiple parts (i.e., two, three, or more pieces) where a size or other consideration makes it desirable from a manufacturing standpoint to make and assemble (either at a factory or at a job site) smaller sub-components. For example, a modified support 20B (FIGS. 14-16) is made of multiple parts (one center piece 40B and two side pieces 41B) adhered together, and FIGS. 17-18 are top and side views of one of those individual parts (side piece 41B) and FIGS. 19-20 are top and side views of another one of those individual parts (center piece 40B). Side piece 41B includes the cavity 30B. Center piece 40B includes a pair of cavities 31B. Center piece 40B includes side surfaces 43B with an offset 44B forming a vertical abutment line, and side pieces 41B includes an inside surface 45B with mating offset 46B for abutting offset 44B. Surfaces 43B and 44B abut and interfit to both locate and assist in assembly at the factory (or on site), such as with adhesive or other attachment means. It is contemplated that other shapes could also used to assist with assembly. Notably, the assembled support 20B must preferably be accurately assembled so that the lips/fingers 25B engage a pipe pressed into the cavity 23B with sufficient force to retain the support on the line pipe and also without breaking the support during assembly. The illustrated assembly of FIGS. 15-16 are similar in dimensions to the support in FIGS. 11-13.

It is to be understood that variations and modifications can be made on the aforementioned structure without departing from the concepts of the present invention, and further it is to be understood that such concepts are intended to be covered by the following claims unless these claims by their language expressly state otherwise.

1. A support for line pipe with known diameter, comprising:
a foam block cut to define a concavity shaped to receive the line pipe of known diameter.

2. The support of claim 1, wherein the foam block includes opposing fingers defining an entrance into the concavity, the opposing fingers rising above a center line of the diameter.

3. The support of claim 2, wherein an end of the fingers defines a distance therebetween slightly less than the diameter, such that the fingers frictionally engage and retain the line pipe when the block is forced into the concavity.

4. The support of claim 1, wherein the foam block has a density of at least 0.8 pound per cubic foot.

5. The support of claim 1, wherein the foam block has a density of less than 3 pounds per cubic foot.

6. The support of claim 1, wherein the foam block is sufficient in size and volume to act as a flotation device for carrying the line pipe on one of soft soil, unstable soil, mud or water.

7. A line pipe installation comprising:
a length of line pipe; and
a plurality of the supports defined in claim 1, each of said supports being attached to the line pipe.

8. The line pipe installation of claim 7, wherein the line pipe includes pipe sections welded together, and wherein the supports include at least one support at a center location on each pipe section.

9. The line pipe installation of claim 7, wherein at least one support is positioned near each end of each pipe section.

10. The support of claim 2, wherein the fingers each include a tip with an angled interior surface that facilitates the fingers sliding over a round surface of the line pipe without permanent deformation or damage.

11. The support of claim 1, wherein the concavity is designed to hold an entire mass of the block suspended on the line pipe.

12. The support of claim 2, wherein the fingers are configured to deflect when a force is applied in the direction of a center of a round section of pipe and are configured to stay substantially about the center of the round section.

13. The support of claim 1, wherein the block is sufficient in size and shape to act as a flotation device for the line pipe until such time as the line pipe is sunk to a bottom of a body of water.

14. The support of claim 1, wherein the entire block weight is less than about 50 pounds.

15. The support of claim 14, wherein the entire block weight is less than about 10 pounds.

16. The support of claim 15, wherein the entire block weight is less than about 5 pounds.

17. The support of claim 1, wherein the concavity is configured to receive a line pipe having a diameter of at least 1 inch.

18. The support of claim 17, wherein the concavity is configured to receive a line pipe having a diameter of at least 12 inches.

19. The support of claim 18, wherein the concavity is configured to receive a line pipe having a diameter of at least 24 inches.

20. The support of claim 19, wherein the concavity is configured to receive a line pipe having a diameter of at least 36 inches.

21. A method comprising steps of:
providing interconnected pipe sections forming a line pipe construction;
placing pre-formed foam supports on the interconnected pipe sections; and
resting the line pipe on the foam supports and the foam supports on a floor surface to thus support the line pipe.

22. The method of claim 21, including a step of pre-forming the foam supports to include a concavity shaped to receive the line pipe and to include opposing fingers that define an entrance to the concavity.

23. The method of claim 22, wherein the fingers define a distance therebetween that is slightly less than a diameter of the pipe sections.
